(19) United States
(12) Patent Application Publication
(10) Pub. No.: US 2021/0073163 A1
(43) Pub. Date: Mar. 11, 2021

(54) LAPTOP DISPLAY COVER WITH ANCILLARY DATA PORT HUB

(71) Applicant: Allec Isshac, Westchester, IL (US)

(72) Inventor: Allec Isshac, Westchester, IL (US)

(21) Appl. No.: 17/053,098

(22) PCT Filed: Nov. 21, 2018
(86) PCT No.: PCT/US18/62346

§ 371 Date: Nov. 5, 2020

Related U.S. Application Data
(60) Provisional application No. 62/764,147, filed on Jul. 20, 2018.

(51) Int. Cl. G06F 13/40; G06F 1/16

(52) U.S. Cl. CPC G06F 13/4068; G06F 2213/0042; G06F 1/1641

(57) ABSTRACT

A laptop display cover with ancillary data port hub that includes a protective panel sized and structured to securely contain a laptop display. The protective panel comprises an exterior surface opposing an interior surface and a cover perimeter edge extending perpendicularly from the interior surface. The protective panel is coupled to an ancillary data port hub on its exterior surface that includes at least a group of data communication ports. The group of data communication ports are of a complementary coupling configuration with removable devices. The ancillary data port hub is operably configured to communicatively couple to at least one of the data communication ports contained on a laptop base, thereby transmitting data to and from a removable device and a laptop and allotting multiple additional data communication ports to a laptop device.

### CROSS-REFERENCE TO RELATED APPLICATION

This application is a national stage filing of International Application Number PCT/US18/62346, filed Nov. 21, 2018, which claims priority to U.S. Provisional Patent Application No. 62/764,147 filed Jul. 29, 2018, the entirety of which is incorporated by reference.

### FIELD OF THE INVENTION

The present invention relates generally to protective laptop covers, and, more particularly, relates to a laptop cover device with a communications hub having various communication port(s), e.g., USB.

### BACKGROUND OF THE INVENTION

Typically, a protective laptop cover is a shell that encloses a laptop and is meant to protect it from damage due to regular wear and tear, such as scratches, dents, falls, cracks, smudges, liquid spills, and the like. Laptops are usually expensive pieces of business or personal property, and therefore users often purchase protective laptop covers in order to best guard and preserve them for as long as possible. As technology continues to develop, laptops, tablets, and other technological items are getting more and more compact, becoming thinner, smaller, and lighter in weight facilitating transportation and storage. As a result of these continuing changes, laptops in particular are beginning to incorporate less features and focus solely on the necessities. For these reasons, manufacturers have begun to incorporate fewer communication ports, such as USB ports, based on the idea that, if needed, users may purchase additional accessories to fit their individual needs. However, purchasing multiple accessories may become costly and burdensome for a user. As such, development of protective laptop covers which incorporate multiple functionalities have emerged. These efforts, however, have failed to address the need for a protective laptop cover which also incorporates an embedded communications hub having communication port(s).

Several known protective covers for electronic devices are aimed at maintaining touch sensitive features while providing a protective layer over the electronic device, thus, preventing it from damage. In some of these devices, the protective layer is capable of rotating and doubles as a privacy screen to be placed over the electronic device's screen and hinder the public's view of the screen at specific angles. However, these devices are typically used for the protection of the device or a user's privacy and do not have an embedded communications hub allotting extra communication port(s) to the device.

Other known protective covers for electronic devices incorporate a slidable panel capable of holding papers, additional computer displays, and the like, thereby allowing a user to view multiple documents at ease while utilizing the electronic device. However, these covers are designed to accomplish the objective of viewing multiple documents at the same time or extending the electronic device's screen view and not producing extra communication port(s) for the device.

Some other known protective covers for electronic devices are aimed at being extremely durable, specifically being waterproof and crush-proof, such as U.S. Pat. No. 7,907,394 (Richardson et al.). These protective covers also feature an attachable wire coupled to a communications hub embedded on the device which has communication port(s). However, there are several drawbacks to these devices; for example, these devices incorporate a combination of different materials as well as small parts and pieces, thereby making them more expensive, are bulky and heavy in weight in order to accomplish their crush-proof and waterproof capabilities, and are complex and complicated to assemble.

Other known protective covers for electronic devices are aimed at being adjustable to fit multiple electronic device models, such as U.S. Pat. No. 7,921,997 (Burns). These protective covers also feature an attachable wire which may be coupled to a communications hub which has communication port(s). However, there are also several drawbacks to these devices; for example, these devices also incorporate a combination of different connective materials consisting of a multitude of small parts and pieces, thereby making them more expensive and bulky, and are extremely complex and complicated to assemble as they do not incorporate all features into a singular, simple device.

Therefore, a need exists to overcome the problems with the prior art as discussed above.

### SUMMARY OF THE INVENTION

The invention provides a laptop display cover with ancillary data port hub that overcomes the hereinafore-mentioned disadvantages of the heretofore-known devices and methods of this general type and that efficiently incorporates a protective laptop cover and an embedded communications hub having communication port(s) in a singular accessory.

With the foregoing and other objects in view, there is provided, in accordance with the invention, a laptop display cover with ancillary data port hub in combination with a laptop computer. The laptop computer having a base with at least one data port rotatably coupled to a display having a screen. The display having a closed position with respect to the base and an open position with respect to the base. The display having a rear surface opposing the display screen of the laptop computer with a rear surface area defined by rear perimeter edges of the display. The laptop display cover with ancillary data port hub comprises a laptop display cover selectively removably coupled to the display and made of a substantially rigid material, with an outer surface, an inner surface opposing the outer surface, with a cover perimeter edge surrounding the laptop display cover. When applied to the display, it covers the rear surface area. The laptop display cover with ancillary data port hub also comprises an auxiliary data communication hub on the outer surface of the laptop display cover, having at least one cover data communication port disposed therein, and defining, with the cover perimeter edge, a cover cavity with the display disposed therein. The laptop display cover with ancillary data port hub also comprises a data communication cord with a terminal first end having a data connector operably configured to communicatively and securely couple with the at least one data port on the base of the laptop computer and a second end communicatively coupled to the auxiliary data communication hub. The data communication cord being operably configured to communicate data from the at least one cover data communication port to the at least one data port of the base of the laptop computer.

In accordance with another feature, the second end of the data communication cord is selectively removably coupled to the auxiliary data communication hub of the laptop display cover.

In accordance with another feature, the terminal first end of the data communication cord, at least one of the cover data communication ports, and at least one of the data ports of the base of the laptop computer consist essentially of at least one of a group of a universal serial bus (USB) port, a high definition multimedia interface (“HDMI”) port, and an SD card slot. Moreover, the terminal first end of the data communication cord and at least one of the cover data communication ports are of a complementary coupling configuration with respect to at least one of the data ports on the base of the laptop computer.

In accordance with another feature, at least one of the data ports on the base of the laptop computer is located on a side of the base and faces in an outward orientation away from the base and at least one of the cover data communication ports of the auxiliary data communication hub faces in the outward orientation away from the base.

In accordance with another feature, at least one of the data ports on the base and at least one of the cover data communication ports of the auxiliary data communication hub are disposed in a substantially parallel orientation with one another when the display is in the closed position with respect to the base.

In accordance with another feature, at least one of the data ports on the base and at least one of the cover data communication ports of the auxiliary data communication hub are disposed on the same side of the base.

In accordance with another feature, at least one of the data ports on the base and at least one of the cover data communication ports of the auxiliary data communication hub are disposed proximal (approximately 6-10 inches) to one another when the display is in the open position with respect to the base.

In accordance with another feature, the display includes an outer perimeter edge spanning around the display. The laptop display cover further comprises a plurality of clip members disposed on the cover perimeter edge in a protruding configuration and configured to engage with the outer perimeter edge of the display and secure the laptop display cover into place.

In accordance with another feature, the outer perimeter edge of the laptop display cover includes two opposing side edges flanking a front edge of the outer perimeter edge, wherein at least one of the plurality of clip members is disposed on each of the two opposing side edges, respectively, and at least one of the plurality of clip members is disposed on the front edge of the outer perimeter edge of the display cover.

In some embodiments, the laptop display cover with an auxiliary data port hub comprises a cover body of a substantially rigid material. Moreover, the cover body comprises an outer surface, an inner surface opposing the outer surface, and a cover perimeter edge surrounding the laptop display cover. The cover body comprises an auxiliary data communication hub on the outer surface of the laptop display cover and has at least one cover data communication port disposed therein. The cover body defines, with the cover perimeter edge, a cover cavity shaped and sized to receive a display of a laptop computer. The cover body also comprises a plurality of clip members disposed on the cover perimeter edge in a protruding configuration and configured to engage with an outer perimeter edge of the display of the laptop computer. The cover body also comprises a data communication cord with a terminal first end having a data connector operably configured to communicatively and securely couple with at least one data port on a base of the laptop computer and a second end communicatively coupled to the auxiliary data communication hub, the data communication cord operably configured to communicate data from at least one of the cover data communication ports to at least one of the data ports on the base of the laptop computer.

In accordance with another feature, the second end of the data communication cord further comprises a removably coupled data connector operably configured to communicatively and securely couple with the auxiliary communication hub.

In accordance with another feature, the terminal first end of the data communication cord, at least one of the cover data communication ports, and at least one of the data ports on the base of the laptop computer consist essentially of at least one of a group of a USB port, an HDMI port, and an SD card slot. Moreover, the terminal first end of the data communication cord and at least one of the cover data communication ports are of a complementary coupling configuration with respect to at least one of the data ports on the base of the laptop computer.

In accordance with another feature, the laptop display cover is of a substantially rectangular shape, having two opposing side edges, a front edge, and a bottom edge.

In accordance with another feature, each of the two opposing side edges, front edge, and bottom edge of the outer perimeter edge further comprises at least one of the plurality of clip members.

In accordance with another feature, the data communication hub further comprises a Bluetooth transceiver operably configured to communicate data to and from a Bluetooth receiver on a base of the laptop computer.

In some embodiments, the laptop display cover with an auxiliary data port hub comprises a protective enclosure of a substantially rigid material. Moreover, the protective enclosure comprises an outer surface, an inner surface opposing the outer surface, defining a cover surface area. The protective enclosure comprises a cover perimeter edge outlining the cover surface area having at least a front edge, a first side edge, and a second side edge, each respectively extending perpendicularly from the inner surface of the laptop display cover and creating a cover cavity shaped and sized to surround a display of a laptop computer. The cover perimeter edge having a plurality of clip members disposed on the cover perimeter edge in a protruding configuration and configured to engage with an outer perimeter edge of the display of the laptop computer. The protective enclosure comprising an auxiliary data communication hub coupled to the outer surface of the laptop display cover and having at least one cover data communication port disposed therein which comprises at least one of a group of a USB port, an HDMI port, and an SD card slot. Access to the cover data communication port is located proximal to the cover perimeter edge, disposed in an outward orientation away from the opposing edge.

One objective of the present invention is to provide a protective laptop cover to protect an electronic device from regular wear and tear, such as scratches, dents, falls, cracks, smudges, liquid spills, and the like.

Another objective is to provide a laptop with an additional communications hub having multiple communication port(s), e.g., USB(s).

Although the invention is illustrated and described herein as embodied in a laptop display cover with ancillary data port hub, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time. Also, for purposes of description herein, the terms “upper”, “lower”, “left,” “rear,” “right,” “front,” “vertical,” “horizontal,” and derivatives thereof relate to the invention as oriented in the figures and is not to be construed as limiting any feature to be a particular orientation, as said orientation may be changed based on the user's perspective of the device. Furthermore, there is no intention to be bound by any expressed or implied theory presented in the preceding technical field, background, brief summary or the following detailed description.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is a perspective view of a laptop display cover with ancillary data port hub according to one embodiment of the present invention;

FIG. 2 is an elevational left side view of a laptop display cover with ancillary data port hub in accordance with the present invention;

FIG. 3 is a top plan view of the interior of a laptop display cover with ancillary data port hub in accordance with the present invention;

FIG. 4 is an elevational side view of the bottom of a laptop display cover with ancillary data port hub in accordance with the present invention;

FIG. 5 is an elevational side view of the top of a laptop display cover with ancillary data port hub in accordance with the present invention;

FIG. 6 is a perspective view of a laptop display cover with ancillary data port hub attached to an open laptop in accordance with an exemplary embodiment of the present invention;

FIG. 7 is a perspective view of a laptop display cover with ancillary data port hub attached to a closed laptop in accordance with an exemplary embodiment of the present invention;

FIG. 8 is an exploded view of a laptop display cover with ancillary data port hub attached to an open laptop; and

FIG. 9 is an exploded view of a laptop display cover with ancillary data port hub in accordance with the present invention.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms. Therefore, specific structural and functional details disclosed herein are not to be interpreted as limiting, but merely as a basis for future claims and as a representative basis for teaching one of ordinary skill in the art to variously employ the present invention in virtually any appropriately detailed structure. Further, the terms and phrases used herein are not intended to be limiting; but rather, to provide an understandable description of the invention. It is believed that the invention will be better understood from a consideration of the following description in conjunction with the drawing figures, in which like reference numerals are carried forward. The figures of the drawings are not drawn to scale.

The present invention provides a novel and efficient laptop display cover with ancillary data port hub. More specifically, the invention provides a protective laptop cover having a communications hub coupled thereto, wherein the hub includes one or more communication port(s), e.g., USB, HDMI. Thereby, the present invention effectively allows for dual functionalities, namely, device protection and additional communication port(s), in a single cost-effective accessory.

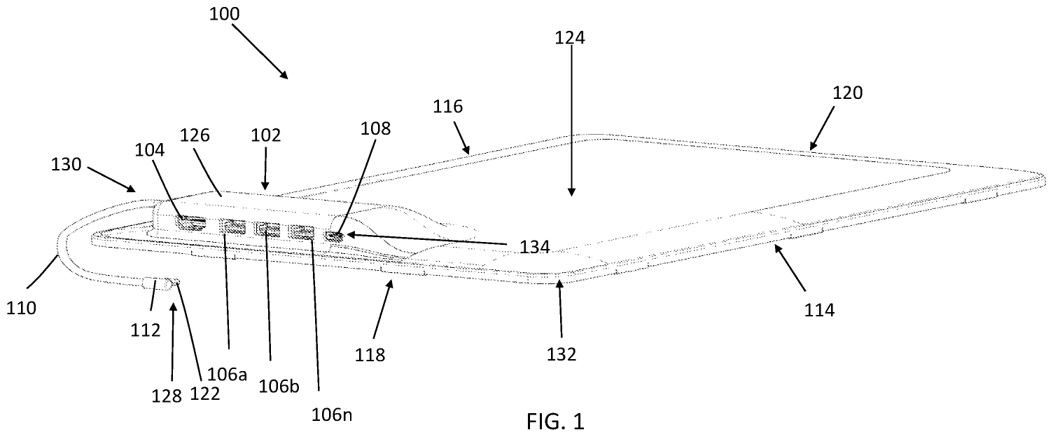

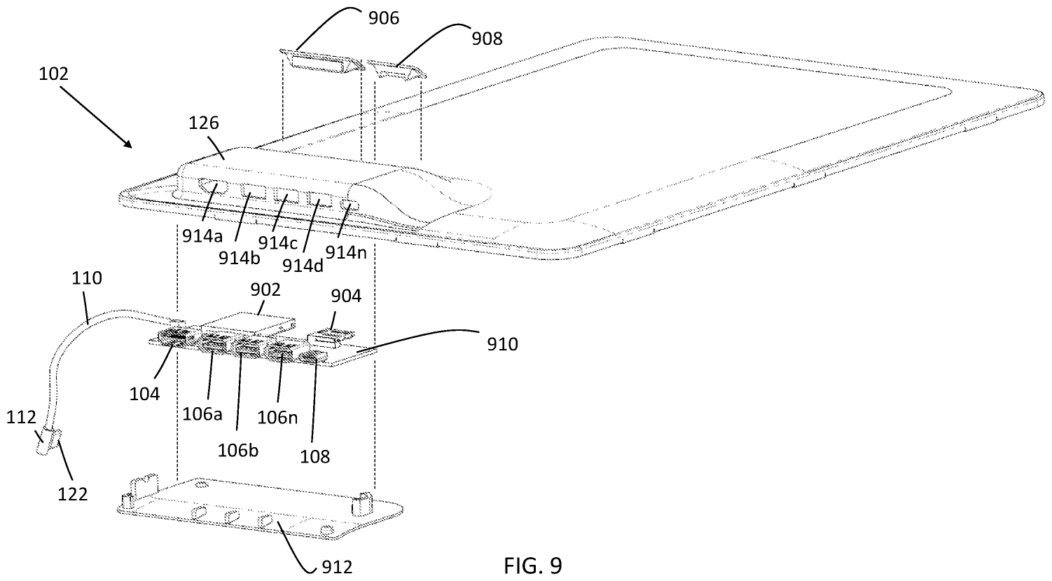

Referring now to FIG. 1, an exemplary embodiment of the present invention is shown in a perspective view. FIG. 1, along with other figures, show several advantageous features of the present invention, but, as will be described below, the invention can be provided in several shapes, sizes, combinations of features and components, and varying numbers and functions of the components. An example of a laptop display cover with ancillary data port hub 100 as shown in FIG. 1, includes auxiliary data communication hub 102. The communication hub 102 includes one or more data communication port(s) 134. Said differently, the hub 102 may include a plurality of data communication port(s) 134. In an exemplary embodiment, the group of data communication ports 134 of the communication hub 102 may include an HDMI port 104. The communication hub 102 may also usefully include three downstream USB Type-A communication ports 106a-n, where “n” represents any number greater than one. The communication hub 102 may also include a USB Type-C communication port 108. The communication hub 102 is communicatively coupled to a data communication cord 110 having a terminal first end 128 and a second end 130. On the terminal first end 128, the data communication cord 110 is coupled to a molded connector cover 112. The molded connector cover 112 may comprise an upstream USB Type-C communication connector 122. The second end 130 is communicatively and/or electrically coupled to the communication hub 102, e.g., by a soldered connection to a circuit board 910 (shown in FIG. 9) housed within the hub 102. In other embodiments, the second end 130 of the data communication cord 110 may comprise an upstream data communication connection communicatively, removably coupled to the communication hub 102.

In other embodiments, the terminal first end 128 of data communication cord 110 comprising the upstream USB Type-C communication connector 122 may instead comprise any other sort of data cable connector, such as a USB Type-A communication connector, a USB Type-B communication connector, a video-graphics array (VGA) communication connection, or an HDMI communication connector.

In other embodiments, the communication hub 102 may instead transfer data wirelessly, such as by utilizing Bluetooth technology. The communication hub 102 may include a Bluetooth transceiver to transmit and receive information. Said another way, the communication hub 102 may not include a data communication cord 110, molded connector cover 112, or upstream USB Type-C communication connector 122, and may instead use wireless communication methods, such as Bluetooth or Zigbee. In another embodiment, a fiber optic connection or another communication means and structure may be utilized. In one embodiment, the communication hub 102 may also include SD card slots 902 and 904 (as best shown in FIG. 9).

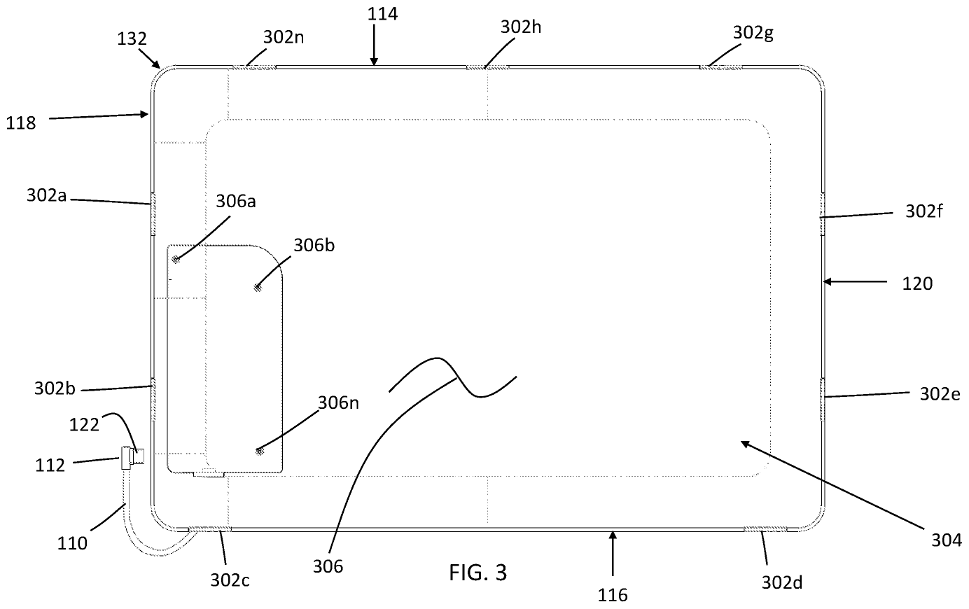

With reference to FIGS. 1 and 3, the laptop display cover 100 may include an outer perimeter edge 132. The outer perimeter edge 132 consists of a front edge 114, a bottom edge 116 opposing the front edge 114. The length between the front and bottom edges 114, 116 define a height of the laptop display cover 100. The outer perimeter edge 132 of laptop display cover 100 may also include a first side edge 118, a second side edge 120 opposing the first side edge 118. The space between the first and second side edges 118, 120 defines a width of the laptop display cover 100. The laptop display cover 100 may also include a substantially planar exterior surface 124, and a substantially planar interior surface 304 opposing the exterior surface 124. The front edge 114, bottom edge 116, first side edge 118, and second side edge 120 of the outer perimeter edge 132 may be located on a flange, raised and extended perpendicular to the interior surface 304. A cover cavity 306 is defined by the interior surface 304 and outer perimeter 132 of the display cover 100.

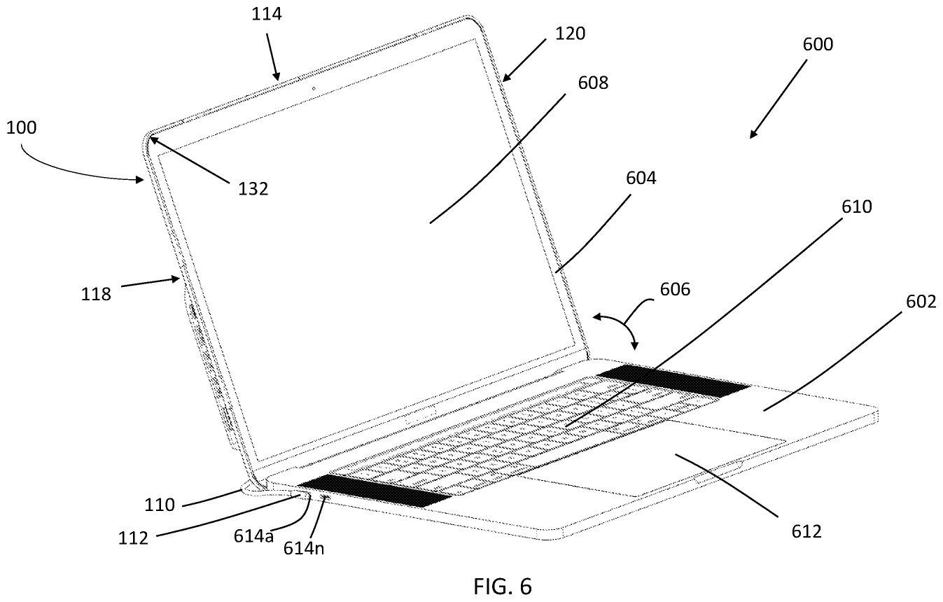

In one embodiment, the laptop display cover 100 may be substantially rectangular and further include rounded corners. In other embodiments, the laptop display cover 100 may be of any shape or size configured to receive a laptop display 604 (shown best in FIG. 6). Common laptop display sizes range from approximately 13-17 inches in height and approximately 6-8 inches in width. For example, the laptop display cover 100 may be of dimensions including, but not limited to (height×width×depth): 11.2×7.8×0.7 inch, 11.98×8.4×0.6 inch, 12×7.6×0.5 inch, 12×8.5×0.6 inch, 12.4×8.7×0.6 inch dimension, 12.8×9×1 inch, 12.9×9×0.8 inch, or any other dimension configured to receive the laptop display 604 (shown best in FIG. 6).

In one embodiment, the laptop display cover 100 may be of a semi-rigid polymeric material (e.g., acrylic, rubber, PVC, acrylonitrile butadiene styrene/polycarbonate, polypropylene with a Shore D hardness of approximately 20-60), or any other substantially rigid material that is operable to cover and protect an electronic device, e.g., a laptop.

In a further embodiment, the placement of communication hub 102 on the laptop display cover 100 is located and coupled to the exterior surface 124 and near the corner located at the first side edge 118 and bottom edge 116, wherein access to the HDMI port 104, the three downstream USB Type-A communication ports 106a-n, and the USB Type-C communication port 108 are each facing outward toward first side edge 118 and the second end 130 of the data communication cord 110 is facing outward toward the bottom edge 116 of laptop display cover 100.

In a further embodiment, as best depicted in FIG. 3, which illustrates a perspective view a laptop display cover 100 shown from the interior surface 304, the communication hub 102 may be attached onto the exterior surface 124 of laptop display cover 100 utilizing screw members 306a-n, where “n” represents any number greater than one. In other embodiments, the communication hub 102 may be coupled to the exterior surface 124 of laptop display cover 100 by any means whereby the communication hub 102 can be secured. This includes fastening, gluing, adhering, or any other method for securing two components together. In other embodiments, the communication hub 102 may be incorporated as part of the continuous structure of laptop display cover 100. Said another way, the communication hub 102 may not include a method of attaching, fastening, or adhering to the exterior surface 124; rather, it may instead be incorporated into the molding of the exterior surface 124 of laptop display cover 100.

In a further embodiment, best depicted in FIG. 9, which illustrates a perspective view of the laptop display cover 100 showing the communication hub 102 in an exploded state, the communication hub 102 comprises an upper casing member 126 and a lower casing member 912 fixed to each other for defining an interior space therebetween to accommodate circuit assembly 910. The upper casing member 126 includes shaped orifices 914a-n, where “n” represents any number greater than one. Shaped orifices 914a-n provide access to the circuit assembly 910. Although a particular number of ports or slots are depicted, the circuit assembly 910 may include one or more HDMI port(s) 104, one or more downstream USB Type-A communication port(s) 106a-n, one or more USB Type-C communication port(s) 108, one or more SDXC card slot(s) 902, and one or more SD card slot(s) 904. The circuit assembly 910 may also include the data communication cord 110 coupled to the molded connector cover 112 comprising the upstream USB Type-C communication connection 122. An SDXC slot casing member 906 and an SC slot casing member 908 are selectively removably attached to the upper casing member 126. In other embodiments, the SDXC card slot 902 may be SDHC card slot. In other embodiments, the SD card slot 904 may be operably configured to communicate with micro SD cards and mini SD cards.

The upstream USB Type-C communication connection 122 is communicatively coupled to the data communication cord 110. Moreover, the data communication cord 110 is communicatively coupled to the circuit assembly 910 and is capable of receiving and transmitting data to and from a variety of removable devices (not pictured), such as a USB, memory card, etc. of a complementary coupling configuration such that it may be plugged into at least one of the group of data communication ports 134, such as the HDMI port 104, the three downstream USB Type-A communication ports 106a-n, or the USB Type-C communication port 108. The data communication cord 110 and the USB Type-C communication connection 122 are operably configured to instantaneously communicate the data received from the removable device to a laptop device.

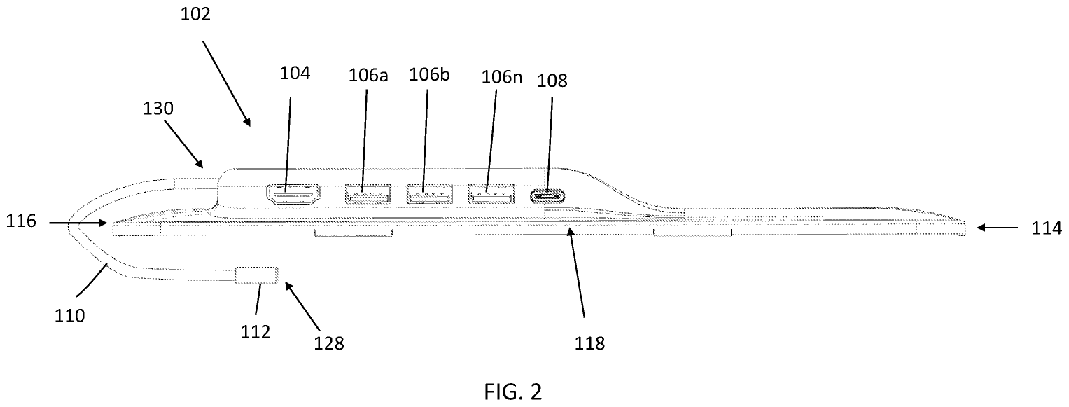

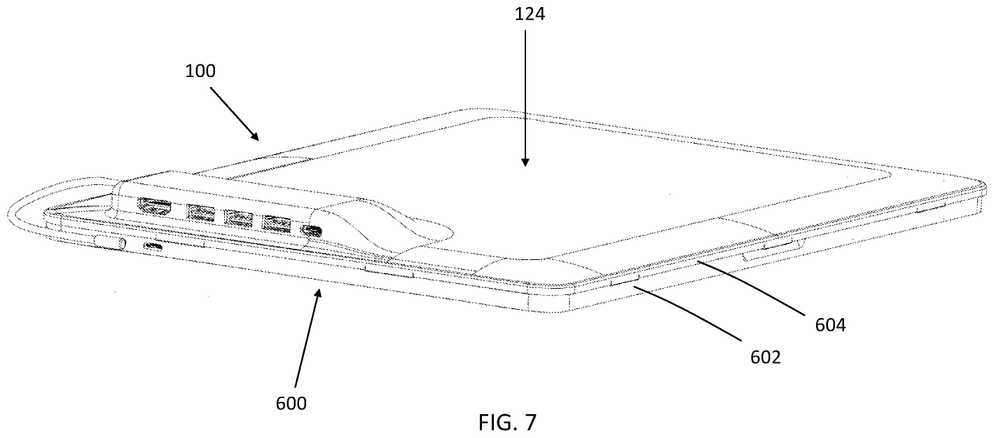

Referring to FIGS. 1-3 and 8-9, the laptop display cover 100 may attach to a laptop device 600 in any manner capable of securing it in place. In one embodiment, best shown in FIG. 3, the laptop display cover 100 may also beneficially include a plurality of clip members 302a-n, where “n” represents any number greater than one. The clip members 302a-n effectuate placement of the laptop display cover 100 on the laptop display panel 604. FIG. 3 illustrates a perspective view of the embodiment of a laptop display cover 100 shown from the interior surface 304. A laptop display panel 604 is coupled to the display cover 100 by inserting the display panel 604 into the cavity 306 until the clip members 302a-n extend passed an outer edge of the display panel, thereby engaging the display cover 100 with the laptop display panel 604. The laptop display cover 100 may be coupled and engaged with the laptop display panel 604 when the display panel 604 is in either the open and rotated position (shown in FIG. 6) or the closed position (shown in FIG. 7). The first, second, and front side edges 118, 120, 114 may include at least one clip member. Specifically, clip members 302a, 302b are located on first side edge 118; clip members 302c, 302d are located on bottom edge 116; clip members 302e, 302f are located on second side edge 120; and clip members 302g, 302h, 302n are located on front edge 114.

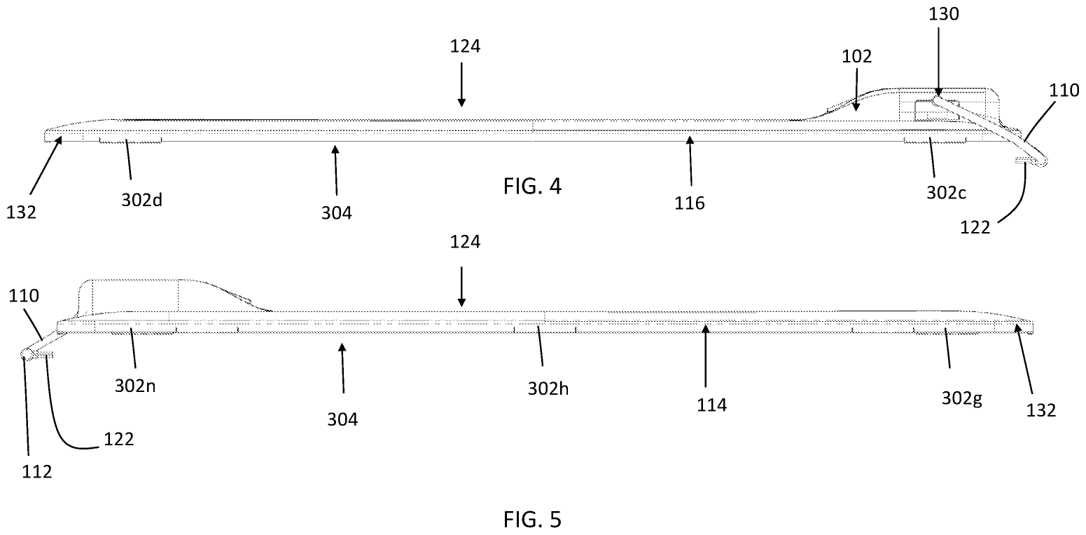

In other embodiments, the placement as well as the number of clip members 302a-n on the outer perimeter edge 132 of laptop display cover 100 may vary. For example, each of the first side edge 118, second side edge 120, and front edge 114 may include at least one clip member. In a further embodiment, best depicted in FIGS. 4-5, the clip members 302a-n may protrude slightly with respect to the outer perimeter edge 132 of the laptop display cover 100, creating an overhang to secure the cover 100 onto a laptop computer 604. Said another way, the clip members 302a-n may have a first portion that extends substantially perpendicular to the interior surface 304 of the cover 100, along with a second portion, referred to as “nose,” that may extend away from the first portion and substantially parallel to the interior surface 304. The nose of the clip members 302a-n may come into direct contact with a perimeter edge 806 of the display 604. In other embodiments, a plurality of tabs may extend inwardly from the outer edges of the laptop display cover 100. These tabs may manually snap into place over the perimeter edge 806 of the laptop display 604 by applying pressure, allowing the laptop display cover 100 to be removably held in place on the display 604.

It should be understood that terms such as, “front,” “rear,” “side,” top,” “bottom,” and the like are indicated from the reference point of a viewer viewing the laptop display cover with ancillary data port hub 100 from the perspective of the interior surface 302 (see FIG. 3).

Referring now to FIG. 6, which depicts a perspective view of the laptop display cover 100, the outer perimeter edge 132 of the cover 100 is snapped over the display 604 of the laptop computer 600. The front edge 114, bottom edge 116, first side edge 118, and second side edge 120 of the laptop display cover 100 may cover at least a portion of the sides of laptop display 604. The laptop display cover 100 is depicted connecting laptop display cover 100 to the laptop 600 via the upstream USB Type-C communication connector 122 (not shown) of laptop display cover 100. Said another way, the laptop display cover 100 is operatively and communicatively coupled to the USB port 614a on the laptop computer 600.

Still referring to FIG. 6, the laptop 600 includes the laptop display 604 rotatably coupled to the laptop base 602. The display 604 includes a substantially planar laptop display screen 608, such as a light emitting diodes (LED) display, a liquid crystal display (LCD) screen, or other form of computer display. The base 602 includes a keyboard 610 including a plurality of input keys and a touchpad 612. The side panel of the laptop base 602 is visible in FIG. 6, as are laptop base data ports 614a-n, where “n” represents any number greater than one. The laptop display 604 is capable of rotation to an open position with respect to laptop base 602 along the laptop rotation path (represented in an exemplary path with lines 606). The laptop display 604 is shown rotated to approximately 110 degrees from laptop base 602. When the laptop 600 and laptop display cover 100 is disposed in an open position, the laptop base data ports 614a-n on laptop base 602 may be disposed proximal (approximately 6-10 inches) to the HDMI port 104, the three downstream USB Type-A communication ports 106a-n, and the USB Type-C communication port 108.

An exemplary embodiment displayed in FIG. 6 shows laptop 600 with laptop base data ports 614a-n comprising USB Type-C communication ports. However, in other embodiments, the USB Type-C communication ports 614a-n may be USB Type-A communication ports, USB Type-B communication ports, or any other data communication connection ports.

FIG. 7 shows the laptop 600 folded into a closed, compact position, wherein the laptop display 604 directly opposes and lays flat on top of laptop base 602. Additionally, when the laptop 600 lays in a closed, compact position, the communication ports 614a-n may be disposed in a substantially parallel orientation with the HDMI port 104, the three downstream USB Type-A communication ports 106a-n, and the USB Type-C communication port 108 (as shown depicted in FIG. 7).

Notably, as can be seen in FIGS. 4-5, there may be no clip members 302a-n present on the central portion located at the bottom edge 116 of laptop display cover 100 which would interfere with the closing of the laptop display 604 onto the laptop base 602. In a further embodiment, the communication hub 102 and the laptop base data ports 614a-n are disposed on the same side of laptop base 602. Those of skill in the art will appreciate that the laptop 600 may comprise components not pictured, such as a motherboard, power supply, central processing unit (CPU), random-access memory (RAM or system memory), hard drive, video card, optical drive (DVD or CD drive), and a variety of input and output devices.

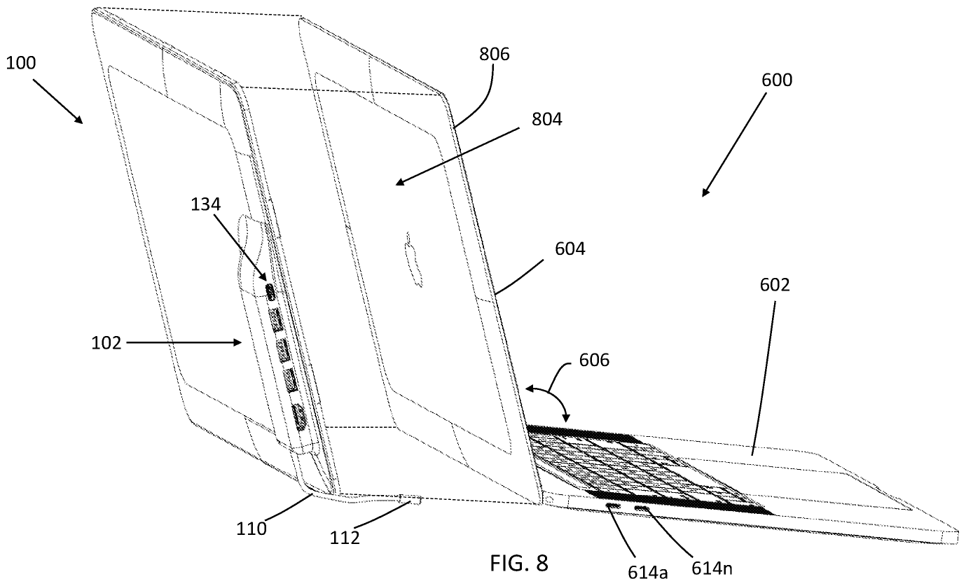

FIG. 8 is an exploded view depicting the laptop display cover 100 removed from the laptop 600. In order to attach laptop display cover 100 to laptop 600, a user merely has to complete the following steps: adjust the laptop display cover 100 to snap over the perimeters of display 604 by placing the cover over rear surface 804 and connect upstream USB Type-C communication connection 122 (not shown) to one of the USB Type-C communication ports 614a-n. Thereafter, by using the communication hub 102, a user may connect a variety of removable devices to the group of data communication ports 134 of laptop display cover 100 which, by way of data communication cord 110, is communicatively coupled to laptop 600.

It should be understood that terms such as, “front,” “rear,” “side,” top,” “bottom,” and the like are indicated from the reference point of a viewer viewing the laptop display cover with ancillary data port hub 100 from the perspective of the interior surface 302 when the laptop display cover with ancillary data port hub 100 is attached to the rear surface 804 of laptop 600 and plugged into one of the USB Type-C communication ports 614a-n (see FIG. 6). The cover cavity is preferably shaped and sized to receive a display of a laptop computer in a tight configuration, e.g., with the outer surface 804 of the laptop 604 proximal to (at or near) the interior surface 304 of the cover 100.

A laptop display cover with ancillary data port hub has been disclosed that includes a substantially rectangular protective panel communicatively coupled to a communications hub. The communications hub includes a variety of ports in which multiple removable devices may be attached. The communications hub is communicatively coupled to a data communication cord and an upstream communication connection. The upstream communication connection is operably configured to effectively communicate and transfer data from the communications hub to and from a laptop device, thus allowing for multiple functionalities in a single device.

1. In combination with a laptop computer having a base with at least one data port and a display having a screen, the display having a closed position with respect to the base, an open position with respect to the base, rotatably coupled to the base of the laptop computer and with a rear surface, opposing the display screen of the laptop computer, having a rear surface area defined by rear perimeter edges of the display, wherein the improvement comprises:
a laptop display cover selectively removably coupled to the display, superimposing the rear surface area, of a substantially rigid material, with an outer surface, with an inner surface opposing the outer surface, a flange extending substantially perpendicular with respect to the inner surface of the laptop display cover and having with a cover perimeter edge surrounding the laptop display cover and including a plurality of clip members disposed thereon, with an auxiliary data communication hub on the outer surface of the laptop display cover and having at least one cover data communication port disposed therein, and defining, with the cover perimeter edge, a cover cavity with the display disposed therein, the plurality of clip members directly and removably contacting the rear perimeter edges of the display when in both the closed position and the open position; and
a data communication cord with a terminal first end having a data connector operably configured to communicatively and securely couple with the at least one data port on the base of the laptop computer and a second end communicatively coupled to the auxiliary data communication hub, the data communication cord operably configured to communicate data from the at least one cover data communication port to the at least one data port of the base of the laptop computer.

2. The improvement according to claim 1, wherein:
the second end of the data communication cord is selectively removably coupled to the auxiliary data communication hub.

3. The improvement according to claim 1, wherein the terminal first end of the data communication cord, the at least one cover data communication port, and the at least one data port of the base of the laptop computer consist essentially of at least one of a group of:
a USB port, an HDMI port, and an SD card slot, the terminal first end of the data communication cord and the at least one cover data communication port are of a complementary coupling configuration with respect to the at least one data port of the base of the laptop computer.

4. The improvement according to claim 1, wherein:
the at least one data port of the base is located on a side of the base and faces in an outward orientation away from the base and the at least one cover data communication port of the auxiliary data communication hub faces in the outward orientation away from the base.

5. The improvement according to claim 4, wherein:
the at least one data port of the base and the at least one cover data communication port of the auxiliary data communication hub are disposed in a substantially parallel orientation with one another when the display is in the closed position with respect to the base.

6. The improvement according to claim 5, wherein:
the at least one data port of the base and the at least one cover data communication port of the auxiliary data communication hub are disposed in the same side of the base.

7. The improvement according to claim 6, wherein:
the at least one data port of the base and the at least one cover data communication port of the auxiliary data communication hub are disposed proximal to one another when the display is in the open position with respect to the base.

8. The improvement according to claim 1, wherein the display includes an outer perimeter edge spanning around the display, wherein:
the plurality of clip members disposed on the cover perimeter edge in a protruding configuration and configured to engage with the outer perimeter edge of the display.

9. The improvement according to claim 8, the outer perimeter edge of the display cover including two opposing side edges flanking a front edge of the outer perimeter edge, wherein:
at least one of the plurality of clip members is disposed on each of the two opposing side edges, respectively, and at least one of the plurality of clip members is disposed on the front edge of the outer perimeter edge of the display cover.

10. A laptop display cover with an auxiliary data port hub coupled to a display, having rear perimeter edges, of a laptop computer comprising:
a cover body:
of a substantially rigid material;
with an outer surface, an inner surface opposing the outer surface, and a cover perimeter edge surrounding the laptop display cover;
with an auxiliary data communication hub on the outer surface of the laptop display cover and having at least one cover data communication port disposed therein;
defining, with the cover perimeter edge, a cover cavity shaped and sized to receive a display of a laptop computer; and
with a plurality of clip members disposed on the cover perimeter edge in a protruding configuration and directly and removably contacting the rear perimeter edges of the display of the laptop computer; and
a data communication cord with a terminal first end having a data connector operably configured to communicatively and securely couple with at least one data port on a base of the laptop computer and a second end communicatively coupled to the auxiliary data communication hub, the data communication cord operably configured to communicate data from the at least one cover data communication port to the at least one data port of the base of the laptop computer.

11. The laptop display cover with an auxiliary data port hub according to claim 10, wherein the second end of the data communication cord further comprises:
a removably coupled data connector operably configured to communicatively and securely couple with the auxiliary communication hub.

12. The laptop display cover with an auxiliary data port hub according to claim 10, wherein the terminal first end of the data communication cord, the at least one cover data communication port, and the at least one data port of the base of the laptop computer consist essentially of at least one of a group of:
a USB port, an HDMI port, and an SD card slot, the terminal first end of the data communication cord and the at least one cover data communication port are of a complementary coupling configuration with respect to the at least one data port of the base of the laptop computer.

13. The laptop display cover with auxiliary data port hub according to claim 12, wherein:
the laptop display cover is of a substantially rectangular shape, having two opposing side edges, a front edge, and a bottom edge.

14. The laptop display cover with auxiliary data port hub according to claim 13, wherein each of the two opposing side edges, front edge, and bottom edge of the outer perimeter edge further comprises:
at least one of the plurality of clip members.

15. The laptop display cover with auxiliary data port hub according to claim 10, wherein the data communication hub further comprises:
a Bluetooth transceiver operably configured to communicate data to a Bluetooth receiver on a base of the laptop computer.

16. A laptop display cover with an auxiliary data port hub coupled to a display, having rear perimeter edges, of a laptop computer comprising:
a protective enclosure:
of a substantially rigid material;
with an outer surface, an inner surface opposing the outer surface, defining a cover surface area;
with a cover perimeter edge outlining the cover surface area having at least a front edge, a first side edge, and a second side edge;
with the front edge, first side edge, and second side edge extending perpendicularly from the inner surface of the laptop display cover;
with the cover perimeter edge creating a cover cavity shaped and sized to surround a display of a laptop computer;
with a plurality of clip members disposed on the cover perimeter edge in a protruding configuration and directly and removably contacting the rear perimeter edges of the display of the laptop computer;
with an auxiliary data communication hub coupled to the outer surface of the laptop display cover and having at least one cover data communication port disposed therein and having at least one of a group of a USB port, an HDMI port, and an SD card slot; and
with access to the at least one cover data communication port located proximal to the cover perimeter edge, disposed in an outward orientation away from the opposing edge.
